(19) United States
(12) Patent Application Publication
(10) Pub. No.: US 2021/0261026 A1
(43) Pub. Date: Aug. 26, 2021

(54) SEATBACK VENTILATION APPARATUS FOR VEHICLES

(71) Applicant: HYUNDAI TRANSYS INCORPORATED, Seosan-si (KR)

(72) Inventors: Ho Sub LIM, Hwaseong-si (KR); Sun Woo KIM, Hwaseong-si (KR)

(21) Appl. No.: 17/172,729

(22) Filed: Feb. 10, 2021

(30) Foreign Application Priority Data
Feb. 20, 2020 (KR) 10-2020-0020797

(51) Int. Cl. B60N 2/56

(52) U.S. Cl. CPC B60N 2/5657; B60N 2/5635

(57) ABSTRACT

Proposed is a seatback ventilation apparatus for vehicles, including a back board, which extends in a planar direction, has an intake hole formed therein to communicate with the outside, and is located at the rear side of the seatback, an intake duct, which is fixed to the front surface of the back board and forms a flow passage through which external air suctioned through the intake hole travels to a discharge hole, a blower, which is located in front of the intake duct, has an air inlet connected to the discharge hole, and suctions external air through the air inlet and delivers the external air to an air outlet, and a connection tube, which is interposed between and connects the blower and a seat pad in order to supply the external air introduced from the air outlet to the seat pad, and is formed to be variable in length.

### CROSS-REFERENCE TO THE RELATED APPLICATION

This application claims priority from Korean Patent Application No. 10-2020-0020797, filed on Feb. 20, 2020, in the Korean Intellectual Property Office, the disclosure of which is incorporated herein by reference in its entirety.

### BACKGROUND OF THE INVENTION

### 1. Field of the invention

The present invention relates to a seatback ventilation apparatus for vehicles.

### 2. Description of the Related Art

The state of indoor air in a vehicle varies depending on the weather. If an occupant of a vehicle sits in a seat for a long time in hot weather, parts of the occupant's body that are in contact with the seat, for example the occupant's back and hips, become sweaty, which gives an unpleasant feeling to the occupant.

Therefore, a seat for vehicles is equipped with a ventilation apparatus to provide a pleasant indoor environment for an occupant. The ventilation apparatus may be mounted to a seat cushion or a seatback of a seat so as to prevent an occupant's hips or back from becoming sweaty.

FIG. 1 is a cross-sectional view of a conventional seatback ventilation apparatus.

Referring to FIG. 1, a conventional seatback ventilation apparatus is structured such that an intake duct 200 is connected to a back board 100 of a seatback 1000, which has an intake hole 110 formed therein, a blower 300 is connected to the seat pad 700, and a sponge member 800 is interposed between the blower 300 and the intake duct 200. The sponge member 800 serves to absorb the displacement of the seat pad 700 when an occupant sits on a seat and to connect the blower 300 and the intake duct 200 to each other.

In this case, however, the sponge member 800 may become permanently deformed by repetitive elastic deformation due to the physical properties thereof, and may have problems related to deterioration in durability, such as air leakage, depending on the use environment. Further, because the blower 300 is directly connected to the seat pad 700, vibration may be transferred to an occupant sitting on the seat pad 700, which may give an unpleasant feeling to the occupant.

The information disclosed in this Background of the Invention section is only for enhancement of understanding of the general background of the invention, and should not be taken as an acknowledgement or any form of suggestion that this information forms the related art already known to a person skilled in the art.

### SUMMARY OF THE INVENTION

Therefore, the present invention has been made in view of the above problems, and it is an object of the present invention to provide a seatback ventilation apparatus for vehicles, in which an intake duct, a blower, and a discharge duct are integrally assembled with a back board of a seatback in order to prevent leakage of external air introduced thereinto, and in which the discharge duct is connected to a seat pad via a corrugated-type connection tube in order to dampen vibrations transferred from the blower to the seat pad.

In accordance with the present invention, the above and other objects can be accomplished by the provision of a seatback ventilation apparatus for vehicles, the seatback ventilation apparatus including a back board extending in a planar direction, the back board having an intake hole formed therein to communicate with the outside, the back board being located at the rear side of a seatback, an intake duct fixed to the front surface of the back board, the intake duct forming a flow passage through which external air suctioned through the intake hole in the back board travels to a discharge hole, a blower located in front of the intake duct, the blower having an air inlet connected to the discharge hole, the blower suctioning external air through the air inlet and delivering the external air to an air outlet, and a connection tube interposed between and connecting the blower and a seat pad in order to supply the external air introduced from the air outlet in the blower to the seat pad, the connection tube being formed to be variable in length.

The seatback ventilation apparatus may further include an elastic member located between the air inlet and the discharge hole, and the elastic member may be made of an elastically deformable material.

The elastic member may dampen vibration, generated by the blower and transferred to the intake duct or the back board, through elastic deformation thereof.

The elastic member may seal the gap between the air inlet and the discharge hole in order to prevent leakage of the external air suctioned into the blower through the air inlet.

The elastic member may be disposed between the outer side of the air inlet and the outer side of the discharge hole, and may be formed in a ring shape so as to be elastically deformed according to the shape of the air inlet or the discharge hole.

The seatback ventilation apparatus may further include a discharge duct located between the blower and the seat pad, and the discharge duct may form a flow passage to connect the air outlet in the blower to the connection tube in order to induce the external air discharged from the blower to flow into the connection tube.

The discharge duct may connect the air outlet in the blower to the connection tube in order to change the flow direction of the external air so that the external air discharged from the air outlet in the blower is introduced into the connection tube, connected to the seat pad in a direction intersecting the planar direction of the seat pad.

The intake duct, the blower, the connection tube, and the discharge duct may be formed into a module, and the module may be integrally assembled with the back board.

The connection tube may be formed as a corrugated tube having a plurality of corrugations, and may be deformable in the longitudinal direction thereof or in a direction intersecting the longitudinal direction thereof.

The connection tube may absorb the displacement of the seat pad through deformation in the longitudinal direction thereof or in the direction intersecting the longitudinal direction thereof.

The connection tube may absorb vibration generated by the blower through deformation in the longitudinal direction thereof or in the direction intersecting the longitudinal direction thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional seatback ventilation apparatus;

FIG. 2 is an exploded perspective view of a seatback ventilation apparatus according to an embodiment of the present invention; and

FIG. 3 is a cross-sectional view of the seatback ventilation apparatus according to the embodiment of the present invention.

### DETAILED DESCRIPTION OF THE PREFERRED EMBODIMENTS

Various exemplary embodiments will now be described more fully with reference to the accompanying drawings, in which only some exemplary embodiments are shown. Specific structural and functional details disclosed herein are merely representative for the purpose of describing exemplary embodiments. The present invention, however, may be embodied in many alternative forms, and should not be construed as being limited only to the exemplary embodiments set forth herein.

Accordingly, while exemplary embodiments of the invention are capable of being variously modified and taking alternative forms, embodiments thereof are shown by way of example in the drawings and will herein be described in detail. It should be understood, however, that there is no intent to limit the present invention to the particular exemplary embodiments disclosed. On the contrary, exemplary embodiments are to cover all modifications, equivalents, and alternatives falling within the scope of the invention.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present invention.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between”, “adjacent” versus “directly adjacent”, etc.).

The terminology used herein is for the purpose of describing particular embodiments only and is not intended to be limiting of exemplary embodiments of the invention. As used herein, the singular forms “a”, “an”, and “the”, are intended to include the plural forms as well, unless the context clearly indicates otherwise. It will be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, exemplary embodiments of the present invention will be described with reference to the accompanying drawings. In the drawings, the same reference numerals refer to the same components.

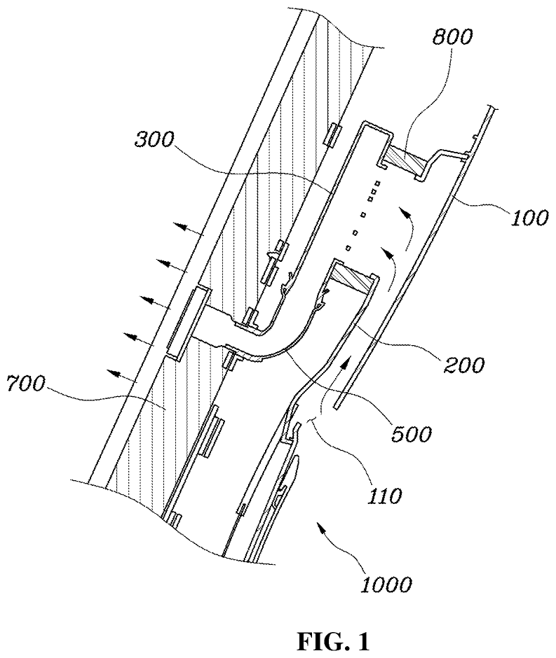

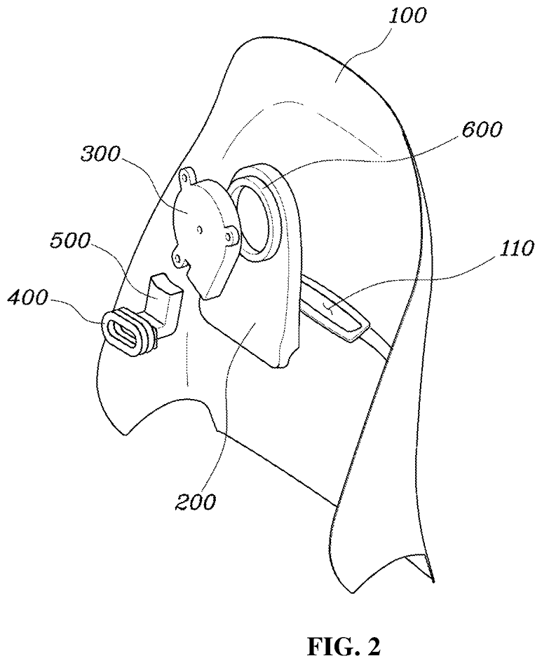

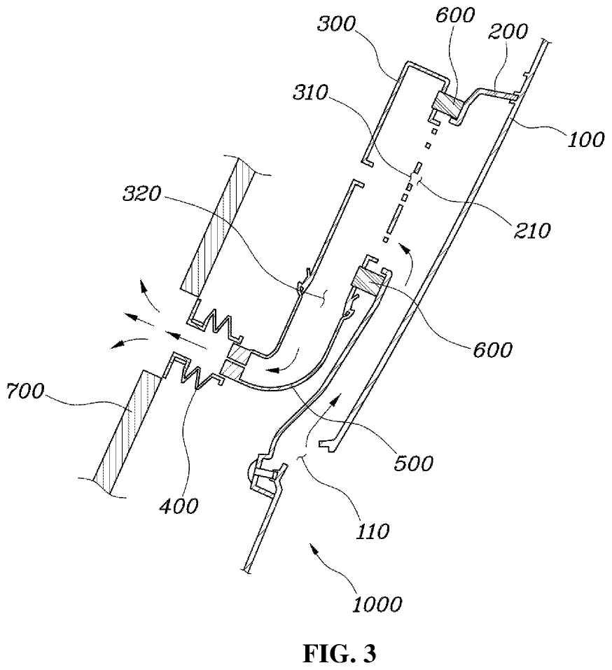

FIG. 1 is a cross-sectional view of a conventional seatback ventilation apparatus. FIG. 2 is an exploded perspective view of a seatback ventilation apparatus according to an embodiment of the present invention. FIG. 3 is a cross-sectional view of the seatback ventilation apparatus according to the embodiment of the present invention.

Referring to FIGS. 1 to 3, a seatback ventilation apparatus for vehicles according to the present invention is structured such that a blower 300, which is mounted inside a seatback 1000, suctions external air through an intake hole 110, which is formed in a back board 100 covering the rear surface of the seatback 1000, and discharges the external air to a seat pad 700 of the seatback 1000, which an occupant's back contacts, thereby giving a pleasant feeling to the occupant sitting in the seat.

A preferred embodiment of the seatback ventilation apparatus for vehicles according to the present invention includes: a back board 100, which extends in a planar direction, has an intake hole 110 formed therein to communicate with the outside, and is located at the rear side of the seatback 1000; an intake duct 200, which is fixed to the front surface of the back board 100 and forms a flow passage through which external air suctioned through the intake hole 110 in the back board 100 travels to a discharge hole 210; a blower 300, which is located in front of the intake duct 200, has an air inlet 310 connected to the discharge hole 210, and suctions external air through the air inlet 310 and delivers the external air to an air outlet 320; and a connection tube 400, which is interposed between and connects the blower 300 and a seat pad 700 in order to supply the external air introduced from the air outlet 320 in the blower 300 to the seat pad 700, and is formed to be variable in length.

Referring further to FIG. 2, the back board 100 serves to cover the rear surface of the seatback 1000, and has the intake hole 110 through which external air passes.

The blower 300 suctions external air through the intake duct 200, which is connected to the intake hole 110, and delivers the external air to the air outlet 320 by changing the pressure in the closed flow passage. Then, the external air delivered to the air outlet 320 flows to the seat pad 700 via the connection tube 400, thereby preventing the occupant's back, which is in contact with the seat pad 700, from becoming sweaty.

The intake duct 200 may be integrally formed with the inner surface of the back board 100 of the seatback 1000. The intake duct 200 connects the intake hole 110 and the air inlet 310 in the blower 300 so that external air is suctioned into the blower 300 without leaking.

The blower 300 has therein the air inlet 310 to suction external air thereinto and the air outlet 320 to discharge the external air therefrom. The blower 300 is connected to the intake duct 200 such that the air inlet 310 and the discharge hole 210 in the intake duct 200 are connected to each other. In this case, the blower 300 may be bolted to the intake duct 200 so as to be securely coupled thereto, thus preventing air leakage through the portion connecting the blower 300 and the intake duct 200.

Referring again to FIG. 1, in the conventional seatback ventilation apparatus for vehicles, because the blower 300 is coupled to the seat pad 700 and is connected to the intake duct 200 via the sponge member 800, vibration of the blower 300 is transferred to the seat pad 700, which gives an unpleasant feeling to the occupant.

In order to solve this problem, the blower 300 has therein the air inlet 310 to suction external air thereinto and the air outlet 320 to discharge the external air therefrom, and is coupled to the intake duct 200 such that the air inlet 310 and the discharge hole 210 in the intake duct 200 are connected to each other, with the result that vibrations are transferred to the back board 100 rather than to the seat pad 700.

In addition, the connection tube 400 connects the air outlet 320 and the seat pad 700 to each other so that the external air discharged from the blower 300 is introduced into the seat pad 700. Further, since the connection tube 400 is formed to be variable in length, when the occupant sits on the seat and leans his/her back against the seatback 1000, the connection tube 400 is capable of absorbing the displacement of the seat pad 700.

The connection tube 400 may be made of an elastic material, such as synthetic resin or rubber, and thus may be deformed in the longitudinal direction thereof.

The seatback ventilation apparatus for vehicles according to the present invention further includes an elastic member 600, which is made of an elastically deformable material and is located between the air inlet 310 and the discharge hole 210.

Referring further to FIGS. 1 and 3, the conventional seatback ventilation apparatus has problems in that the sponge member 800, via which the air inlet 310 and the discharge hole 210 are connected to each other, is permanently deformed depending on the use environment, and in that external air suctioned into the blower 300 leaks. In order to prevent these problems, according to the present invention, the elastic member 600, which is made of an elastically deformable material, such as synthetic resin or rubber, is located between the air inlet 310 and the discharge hole 210, with the result that the blower 300 and the intake duct 200 are securely connected to each other without the concern of permanent deformation of the elastic member 600.

Further, due to the elastic deformation thereof, the elastic member 600 is capable of dampening vibration that occurs during operation of the blower 300 and is transferred to the intake duct 200 or the back board 100.

The occupant sitting on the seat while leaning his/her back against the seatback 1000 may feel uncomfortable due to the vibration that occurs during operation of the blower 300 and is transferred to the intake duct 200 and the back board 100. Therefore, the elastic member 600 is made of an elastically deformable material, such as synthetic resin or rubber, and is located between the blower 300 and the intake duct 200 so as to absorb the vibration generated by the blower 300 using elastic deformation thereof, thereby dampening the vibration transferred to the back board 100, thus reducing the discomfort of the occupant.

Further, the elastic member 600 seals the gap between the air inlet 310 and the discharge hole 210, thereby preventing leakage of the external air suctioned into the blower 300 through the air inlet 310.

During operation of the blower 300, if the external air suctioned thereinto leaks from the flow passage, the operation efficiency of the blower 300 may be deteriorated. In order to prevent this problem, the elastic member 600 is located between the air inlet 310 in the blower 300 and the discharge hole 210 in the intake duct 200 so as to seal the gap between the air inlet 310 and the discharge hole 210, thereby preventing leakage of the external air suctioned into the blower 300, thus increasing the operation efficiency of the blower 300.

The elastic member 600 is disposed between the outer side of the air inlet 310 and the outer side of the discharge hole 210. The elastic member 600 is formed in a ring shape, and is capable of being elastically deformed according to the shape of the air inlet 310 or the discharge hole 210.

The elastic member 600 is located between the outer side of the air inlet 310 and the outer side of the discharge hole 210 in order to prevent leakage of the external air suctioned into the blower 300, and is formed in a ring shape so as to be applied even when the air inlet 310 and the discharge hole 210 have a polygonal shape rather than a circular shape. Accordingly, the elastic member 600 is capable of being mounted to the blower 300 and the intake duct 200 regardless of the shape thereof.

The seatback ventilation apparatus for vehicles according to the present invention further includes a discharge duct 500, which is located between the blower 300 and the seat pad 700 and forms a flow passage to connect the air outlet 320 in the blower 300 to the connection tube 400 in order to induce the external air discharged from the blower 300 to flow into the connection tube 400.

The connection tube 400 may be formed to be longer so as to connect the air outlet 320 in the blower 300 to the seat pad 700 without using the discharge duct 500. However, because the connection tube 400 is made of an elastic material, when it is formed to be longer, it is highly likely to be damaged when connected to other components, and the cost of manufacturing the same increases. In order to prevent these problems, the length of the connection tube 400 is set just enough to absorb the displacement of the seat pad 700 when the occupant leans his/her back against the seat pad 700, and the discharge duct 500 is used to form a flow passage to connect the air outlet 320 to the connection tube 400 in order to induce the external air discharged from the blower 300 to flow into the connection tube 400. As a result, it is possible to reduce the cost of manufacturing the connection tube 400.

The discharge duct 500 connects the air outlet 320 in the blower 300 to the connection tube 400 in order to change the flow direction of the external air so that the external air discharged from the air outlet 320 in the blower 300 is introduced into the connection tube 400, which is connected to the seat pad 700 in a direction intersecting the planar direction of the seat pad 700.

Referring further to FIG. 2, the air outlet 320 in the blower 300 is formed to be oriented in the downward direction, so the external air discharged therefrom flows in the downward direction. The connection tube 400 is connected to the seat pad 700 in a direction intersecting the planar direction of the seat pad 700 in order to induce the external air to flow into the seat pad 700. The discharge duct 500 connects the air outlet 320 to the connection tube 400 so that the flow direction of the external air discharged from the blower 300 in the downward direction is changed to a direction intersecting the planar direction of the seat pad 700.

The intake duct 200, the blower 300, the connection tube 400, and the discharge duct 500 are formed into a module, and this module is integrally assembled with the back board 100.

Since the intake duct 200, the blower 300, the connection tube 400, and the discharge duct 500 are assembled into a module and this module is integrally assembled with the back board 100, the process of assembling these components is simplified, and thus manufacturing costs are reduced.

The connection tube 400 is formed as a corrugated tube having a plurality of corrugations, and is deformable in the longitudinal direction thereof or in a direction intersecting the longitudinal direction thereof.

The connection tube 400, which is made of an elastic material, is formed as a corrugated tube having a plurality of corrugations so as to be deformable in the horizontal direction or the vertical direction intersecting the longitudinal direction thereof. Accordingly, the connection tube 400 is capable of connecting the discharge duct 500 to the seat pad 700 and of being mounted to the seat pad 700 regardless of the shape of the seat pad 700.

Since the connection tube 400 is deformable in the longitudinal direction thereof or in a direction intersecting the longitudinal direction thereof, it is capable of absorbing the displacement of the seat pad 700.

Even when the seat pad 700 of the seatback 1000, against which the occupant leans his/her back, is displaced by the load applied thereto due to contact with the occupant's back, the connection tube 400, which is connected to the seat pad 700, needs to stably induce the external air discharged from the blower 300 to flow into the seat pad 700. In order to induce the external air to flow into the seat pad 700 when the seat pad 700 is displaced, as described above, the connection tube 400 is formed as a corrugated tube so as to be deformable in a direction intersecting the planar direction of the seat pad 700. Accordingly, the connection tube 400 is capable of absorbing the displacement of the seat pad 700, thereby reliably inducing the external air to flow into the seat pad 700 even when the seat pad 700 is displaced due to contact with the occupant's back.

Further, since the connection tube 400 is deformable in the longitudinal direction thereof or in a direction intersecting the longitudinal direction thereof, it is possible to absorb vibration generated by the blower 300.

Referring again to FIG. 1, in the conventional seatback ventilation apparatus, a discharge duct 500 is connected to the blower 300 and is directly connected to the seat pad 700. Accordingly, vibration that occurs during operation of the blower 300 is transferred to the seat pad 700 of the seatback 1000 via the discharge duct 500, thus giving an unpleasant feeling to the occupant sitting on the seat. In order to prevent this problem, according to the present invention, the connection tube 400 connects the discharge duct 500 to the seat pad 700, and is made of an elastic material so as to be deformable in the longitudinal direction thereof or in a direction intersecting the longitudinal direction thereof, thereby absorbing the vibration generated by the blower 300. As a result, the vibration transferred to the seat pad 700 is dampened, thereby reducing the discomfort of the occupant attributable to vibration.

As is apparent from the above description, the embodiment of the present invention is constituted by the back board 100 having the intake hole 110 formed therein, the intake duct 200, the blower 300, the elastic member 600, the discharge duct 500, and the connection tube 400, with the result that external air is induced to flow into the seat pad 700 of the seatback 1000, against which the occupant leans his/her back when sitting on the seat, thereby preventing the occupant's back from becoming sweaty.

In addition, since the elastic member 600 is located between the blower 300 and the intake duct 200, it is possible to prevent leakage of external air suctioned into the blower 300 and to absorb vibration generated by the blower 300, thus dampening the vibrations transferred to the back board 100.

In addition, since the connection tube 400, which connects the discharge duct 500 to the seat pad 700, is formed as a corrugated tube, it is possible to absorb the displacement of the seat pad 700, thus inducing the external air discharged from the blower 300 to flow into the seat pad 700 even when the seat pad 700 is displaced due to contact of the occupant's back with the seatback 1000. Further, the connection tube 400 is capable of dampening vibration transferred to the seat pad 700 by absorbing the vibration generated by the blower 300.

Although exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A seatback ventilation apparatus for vehicles, comprising:
a back board extending in a planar direction, the back board having an intake hole formed therein to communicate with an outside, and located at a rear side of a seatback;
an intake duct fixed to a front surface of the back board, the intake duct forming a flow passage through which external air suctioned through the intake hole in the back board travels to a discharge hole;
a blower located in front of the intake duct, the blower having an air inlet connected to the discharge hole, and suctioning the external air through the air inlet and delivering the external air to an air outlet; and
a connection tube interposed between and connecting the blower and a seat pad in order to supply the external air introduced from the air outlet in the blower to the seat pad, the connection tube being formed to be variable in length.

2. The seatback ventilation apparatus of claim 1, further comprising:
an elastic member located between the air inlet and the discharge hole, the elastic member being made of an elastically deformable material.

3. The seatback ventilation apparatus of claim 2, wherein the elastic member dampens vibration generated by the blower and transferred to the intake duct or the back board, through elastic deformation thereof.

4. The seatback ventilation apparatus of claim 2, wherein the elastic member seals a gap between the air inlet and the discharge hole in order to prevent leakage of the external air suctioned into the blower through the air inlet.

5. The seatback ventilation apparatus of claim 2, wherein the elastic member is disposed between an outer side of the air inlet and an outer side of the discharge hole, and is formed in a ring shape so as to be elastically deformed according to a shape of the air inlet or the discharge hole.

6. The seatback ventilation apparatus of claim 1, further comprising:
a discharge duct located between the blower and the seat pad, the discharge duct forming a flow passage to connect the air outlet in the blower to the connection tube in order to induce the external air discharged from the blower to flow into the connection tube.

7. The seatback ventilation apparatus of claim 6, wherein the discharge duct connects the air outlet in the blower to the connection tube in order to change a flow direction of the external air so that the external air discharged from the air outlet in the blower is introduced into the connection tube connected to the seat pad in a direction intersecting a planar direction of the seat pad.

8. The seatback ventilation apparatus of claim 6, wherein the intake duct, the blower, the connection tube, and the discharge duct are formed into a module, and the module is integrally assembled with the back board.

9. The seatback ventilation apparatus of claim 1, wherein the connection tube is formed as a corrugated tube having a plurality of corrugations, and is deformable in a longitudinal direction thereof or in a direction intersecting the longitudinal direction thereof.

10. The seatback ventilation apparatus of claim 9, wherein the connection tube absorbs a displacement of the seat pad through deformation in the longitudinal direction thereof or in the direction intersecting the longitudinal direction thereof.

11. The seatback ventilation apparatus of claim 9, wherein the connection tube absorbs vibration generated by the blower through deformation in the longitudinal direction thereof or in the direction intersecting the longitudinal direction thereof.
